(19) United States
(12) Patent Application Publication
(10) Pub. No.: US 2008/0173824 A1
(43) Pub. Date: Jul. 24, 2008

(54) SCINTILLATOR PLATE FOR RADIATION

(76) Inventors: Mitsuru SEKIGUCHI, Tokyo (JP); Takehiko Shoji, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/971,518

(22) Filed: Jan. 9, 2008

(30) Foreign Application Priority Data
Jan. 12, 2007 (JP) JP2007-004412

(51) Int. Cl. H01R 4/00

(52) U.S. Cl. 250/370.11

(57) ABSTRACT

A scintillator plate is disclosed comprising on a substrate a metal layer and a phosphor layer capable of emitting light upon exposure to radiation, wherein all of the substrate, the phosphor layer and the metal layer are covered with a moisture-resistant protective film. Also disclosed is a scintillator plate comprising on a metal substrate a phosphor layer capable of emitting light upon exposure to radiation, wherein all of the metal substrate and the phosphor layer are covered with a moisture-resistant protective film.

This application claims priority from Japanese Patent Application No. JP2007-004412 filed on Jan. 12, 2007, which is incorporated hereinto by reference.

### FIELD OF THE INVENTION

The present invention relates to a scintillator plate emitting fluorescence upon exposure to radiation and a radiographic imaging apparatus having a scintillator plate.

### BACKGROUND OF THE INVENTION

There have been broadly employed radiographic images such as X-ray images for diagnosis of patients' conditions in hospitals. Specifically, radiographic images using a intensifying-screen/film system have achieved enhancement of speed and image quality over its long history and are still used for medical treatment.

In recent years, there has appeared a radiation image detecting means of a digital system, as typified by a flat panel type radiation detector (FPD), whereby it has become feasible that a radiation image is obtained as digital information, which can be freely subjected to image processing and is promptly telephotographed.

A radiation image detecting means is provided with a so-called scintillator plate to convert radiation to fluorescence. Upon exposure to radiation having passed through an object the scintillator plate which is constituted of a phosphor layer formed on a substrate, instantaneously emits fluorescence corresponding to the dosage through the phosphor layer.

A radiographic imaging apparatus, as described in JP-A No. 2003-185754 (hereinafter, the term JP-A refers to Japanese Patent Application Publication) is provided with a specific metal layer between a front plate of an enclosure covering a planar radiation detector and a radiation detector.

### SUMMARY OF THE INVENTION

There is a problem in the above-described scintillator plate as a radiation image detecting means that when radiation enters a phosphor layer, a low energy radiation scattered by various members of the radiation image detecting means enters concurrently and disturbs precise image diagnosis, impairing diagnosis performance.

In the radiographic imaging apparatus described in JP-A No. 2003-185754, a metal foil used for prevention of radiation scattering is not a scintillator plate but is a part of the enclosure and disposed outside the scintillator plate. Accordingly, the metal foil is subject to corrosion by moisture of ambient humidity. Further, since the metal foil is apart from the scintillator plate, radiation is scattered.

In view of the foregoing problems, the present invention has come into being.

Thus, one aspect of the invention is directed to a radiation scintillator plate comprising on a substrate, a metal layer and a phosphor layer capable of emitting light upon exposure to radiation, wherein all of the substrate, the phosphor layer and the metal layer are overall covered with a moisture-resistant protective film.

In one of the preferred embodiments of the invention, the scintillator plate comprises on one side of a substrate a phosphor layer capable of emitting light upon exposure to radiation and on the other side of the substrate a metal layer, wherein all of the substrate, the phosphor layer and the metal layer are overall covered with a moisture-resistant protective film.

Further, in one of the preferred embodiments, the scintillator plate comprises on a substrate a metal layer and further on the metal layer, a phosphor layer capable of emitting light upon exposure to radiation, wherein all of the substrate, the metal layer and the phosphor layer are overall covered with a moisture-resistant protective film.

Another aspect of the invention is directed to a radiation scintillator plate comprising on a metal substrate formed of a metal or an alloy a phosphor layer capable of emitting light upon exposure to radiation, wherein all of the metal substrate and the phosphor layer are covered with a moisture-resistant protective film.

Further, another aspect of the invention is directed to a radiographic imaging apparatus comprising a radiation detector enclosed in a housing with being in close contact with a photoelectric conversion device.

The scintillator plate of the invention has realized advantageous effects, as below.

A metal layer used for prevention of scattering and a metal substrate both are inside the protective film of the scintillator plate, whereby the metal layer and the metal substrate are protected from moisture, resulting in enhanced corrosion resistance.

A metal layer and a metal substrate are each close in distance to a phosphor layer, whereby scattered X-rays can be cut off immediately before entering the phosphor layer, resulting in enhanced elimination of scattered X-rays.

In one preferred embodiment of the invention, a metal layer or a metal substrate which is in contact with a phosphor layer, has a columnar structure, which enables to permit X-rays to be parallel to the columnar direction (including image information) to efficiently pass and to efficiently cut-off scattered rays not parallel to the columnar direction (and not including image information). Further, cesium iodide to form a phosphor layer grows based on a columnar structure, promoting growth of columnar crystals of cesium iodide and resulting in enhanced image sharpness.

A phosphor layer formed of a deliquescent substance such as cesium iodide is provided within a moisture-resistant protective film, which prevents metal corrosion due to moisture.

In one preferred embodiment of the invention, an insulation layer is provided between a metal layer or metal substrate which eliminates, as a filter, scattered X-rays and a phosphor layer, which inhibits cell reaction causing metal corrosion.

### BRIEF DESCRIPTION OF THE DRAWINGS

FIG. 1 illustrates a radiographic imaging apparatus 1 relating to the embodiments of the invention.

FIG. 2 illustrates a partially magnified view of FIG. 1.

FIG. 3 illustrates the sectional view of a conventional radiation detector.

FIG. 4 illustrates the sectional view of a radiation detector relating to the invention.

FIGS. 5(a) and 5(b), each illustrates a sectional view of a radiation detector relating to the invention.

FIGS. 6(a) and 6(b), each illustrates the sectional view of a radiation detector relating to the invention.

### DETAILED DESCRIPTION OF THE INVENTION

In the following, the embodiments of the invention will be detailed with reference to the drawings but the invention should not be construed to be limited to these.

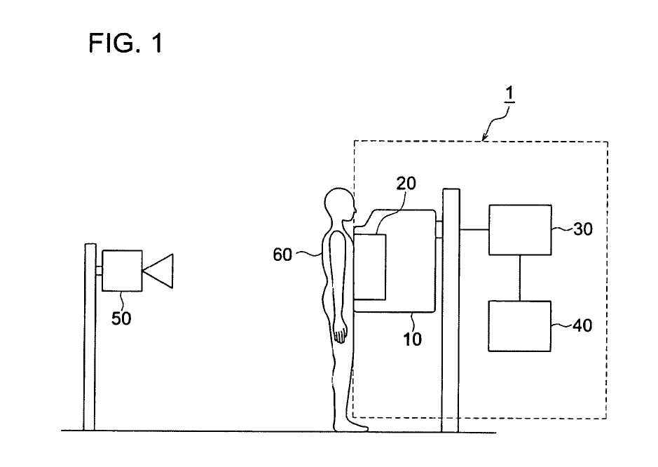

FIG. 1 illustrates a radiographic imaging apparatus 1 relating to the embodiments of the invention.

The radiographic imaging apparatus (1) is provided with a mainframe (10), a radiation detector (20), an image processing means (30) and an image display (40). The main frame (10) is installed with the radiation detector (20) and various instruments within it and fixed at the prescribed position in a radiography room.

Radiographic imaging is performed by detecting, via the radiation detector (20), a radiation that has penetrated a subject (60) and a front plate of the radiation detector (20).

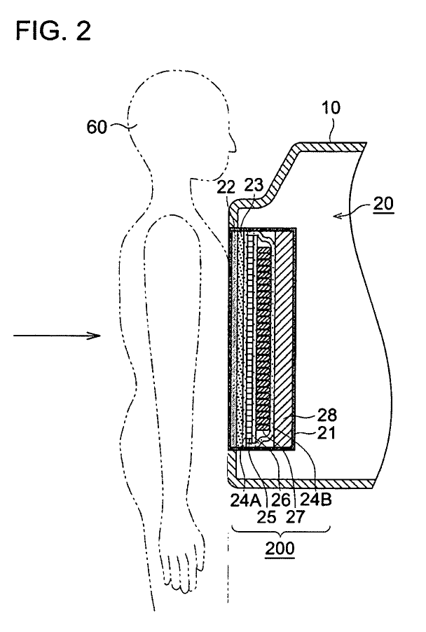

FIG. 2 illustrates a partially magnified view of FIG. 1. The radiation detector (20) is provided, within a housing (21), with a front plate (22), a buffer material (23), a scintillator plate (200) and a photoelectric conversion device (28) constituted of a TFT substrate forming a photodiode.

The scintillator plate (200) is provided with a phosphor layer (27) on a substrate (26). Upon exposure of the scintillator plate (200) to radiation, the phosphor layer (27) absorbs energy of the incident radiation and emits an electromagnetic wave (or light) having a wavelength of 300 to 800 nm, including ultraviolet light, visible light and infrared light.

The scintillator plate (200) is constituted of a metal layer (25), the substrate (26), the phosphor layer (27) and moisture resistant protective films (24A and 24B, hereinafter, also denoted simply as protective films).

The mainframe (10) is made of a highly rigid material, such as carbon fiber-reinforced ABS resin to protect the various instruments installed in the interior thereof.

The front plate (22) of the radiation detector (20) is made of a material exhibiting high radiation transmittance. The thickness of the front plate (22) is preferably from 0.3 to 0.5 mm to maintain strength with securing radiation transmittance. Materials exhibiting relatively high radiation transmittance and high rigidity include an aluminum alloy, a carbon fiber-reinforced resin, an acryl resin, a phenol resin, a polyimide resin and composite materials of these resins and the aluminum alloy.

The front plate (22) compresses the scintillator plate 200 through the buffer material (23) to bring the scintillator plate (200) into close contact with the photoelectric conversion device (28).

The metal layer (25) disposed inside the scintillator plate (200) is constituted of a metal having an atomic number of at least 20 or an alloy having an effective atomic number of at least 20, that is, at least one of metals of, example, Cu, Ni, Fe, Pb, Zn, W, Mo, Au, Ag, Ba, Ta, Cd, Ti, Zr, V, Nb, Cr, Co and Sn. Such metals or alloys, which absorb low energy radiation, efficiently absorb scattered radiation to eliminate it. The effective atomic number refers to an average value of the respective atomic numbers of metals constituting an alloy. In the case of an alloy comprised of Co (atomic number 27) and Cu (atomic number 29) in an atom ratio of 1:1, for instance, its effective atomic number is to be 28.

The thickness of the metal layer (25) is preferably from 5 to 200 μm. A thickness of less than 5 μm results in insufficient function to remove scattered radiation. A thickness of more than 200 μm results in excessive absorption of radiation by the metal layer (25), and leading to a reduced employment efficiency of radiation. The metal layer (25) is made by an electrolysis method or a rolling method.

The protective films (24A and 24B) enclose the metal layer (25), the substrate (26) and the phosphor layer (27), are then adhered and formed in the shape of a bag. The protective films (24A and 24B) preferably exhibit a moisture permeability per day of 50 g/m² or less. In the case of a moisture permeability per day of more than 50 g/m², a phosphor layer (27) of a deliquescence substance such as CsI results in reduced luminance by 10% after being allowed to stand under an environment of 60° C. and 80% RH for 168 hrs., leading to unsatisfied reliability as a product.

The phosphor layer (27) is formed preferably of Cs-based crystals, including, for example, CsI, CsBr and CsCl. The Cs-based phosphor layer (27) may be of crystals formed of plural Cs-based raw materials in an arbitrary ratio.

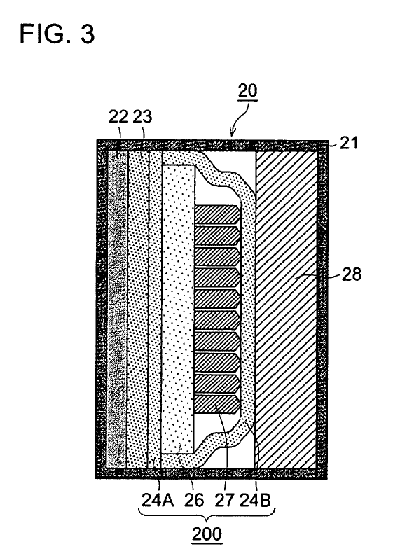

FIG. 3 illustrates the sectional view of a conventional radiation detector (20). A scintillator plate (200) is constituted of a protective film (24A), a substrate (26A), a phosphor layer (27) and a protective film (24B). As shown in FIG. 3, no metal layer is formed within the protective films (24A and 24B).

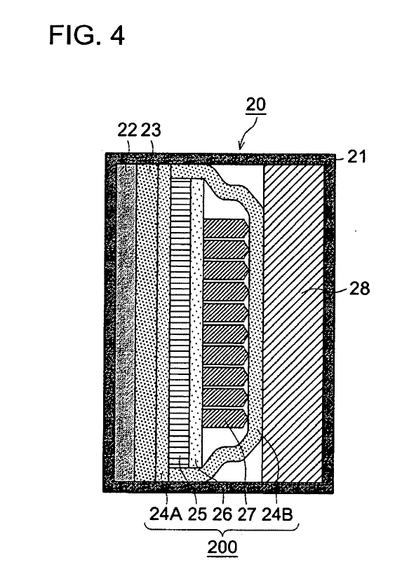

FIG. 4 illustrates the sectional view of a radiation detector (20) according to one embodiment (1) of the invention.

The layer arrangement is constituted of a protective film (24A), a metal layer (25), a substrate (26), a phosphor layer (27) and a protective film (24B) in that order. For instance, the protective film (24A or 24B) is a 50 μm thick laminated film formed of 20 μm PET/0.2 μm vapor-deposited alumina/30 μm polypropylene; the metal layer (25) is a 20 μm thick Cu film; the substrate (26) employs a 125 μm thick polyimide film; and the phosphor layer (27) is a 600 μm thick, vapor-deposited film of 0.03 mol % Tl (thallium)-doped CsI crystals.

In this embodiment (1), X-rays initially enter the metal layer (25). Scattered X-rays generated other portions of the apparatus and causing noise is weak in intensity, absorbed and disappears. Specifically, the metal layer (25) is close in distance to the phosphor layer (27) so that the scattered X-rays are cut-off immediately before being incident to the phosphor layer, resulting in advantages of enhanced elimination of scattered X-rays.

Methods of determining an image deterioration degree due to scattered X-rays include, for example, a measurement of a glare component (contrast lowering due to scattering). The glare of the embodiment (1) was determined according to the lead disc method, as described in T. Okabe & T. Uriya, Iyo Gazo Kogaku (Medical Image Engineering), page 66, published by Ishiyaku Shuppan Co., Ltd. It was shown that when using a 400 mm lead disc, the glare was 0.12% in the absence of the metal layer (25) and 0.3% in the presence of the metal layer, and proving that the metal layer inhibited lowering of contrast due to scattering.

In the embodiment (1), a metal layer (25) to prevent scattering is inside the protective film (24) so that the metal layer (25) is protected from moisture, not causing problems such as corrosion of the copper.

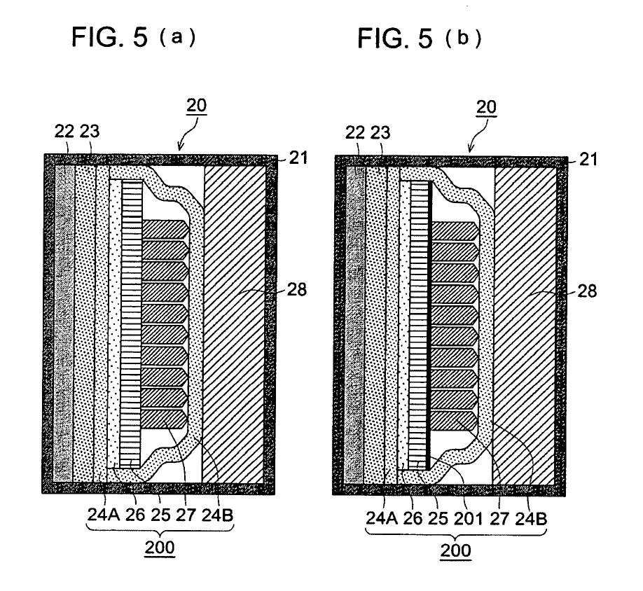

FIG. 5(a) illustrates the sectional view of a radiation detector (20) according to one embodiment (2) of the invention.

The layer arrangement is constituted of a protective film (24A), a substrate (26), a metal layer (25), a phosphor layer (27) and a protective film (24B) in that order. For instance, the protective film (24A or 24B) is a 50 μm thick laminated film formed of 20 μm PET/0.2 μm vapor-deposited alumina/30 μm polypropylene; the substrate (26) is a 125 μm thick polyimide film; the metal layer (25) is a 0.3 mm thick Cu film; and the phosphor layer (27) is a 600 μm thick, vapor-deposited film of 0.03 mol % Tl-doped CsI crystals.

In this embodiment (2), X-rays initially enters the metal layer (25) before entering the phosphor layer (27). Scattered X-rays generated in other portions of the apparatus and causing noise are weak in intensity, absorbed and disappeared. Specifically, the metal layer (25) is close in distance to the phosphor layer (27) so that the scattered X-rays are cut-off immediately before being incident to the phosphor layer, resulting in advantages of enhanced elimination of scattered X-rays.

The metal layer (25) can reflect light emitted from the phosphor layer (27) and the light emitted from the surface layer, which is adversely absorbed in the foregoing embodiment (1), is reflected toward the photoelectric conversion device (28), leading to advantages such that a lower X-ray dose results in a brighter image.

FIG. 5(a) illustrates the sectional view of a radiation detector (20) according to one embodiment (3) of the invention.

The layer arrangement is constituted of a protective film (24A), a substrate (26), a metal layer (25), an insulation film (201), a phosphor layer (27) and a protective film (24B) in that order. For instance, the protective film (24A or 24B) is a 50 μm thick laminated film formed of 20 μm PET/0.2 μm vapor-deposited alumina/30 μm polypropylene; the substrate (26) is a 125 μm thick polyimide film; the metal layer (25) is a 0.3 mm thick Cu film; the insulation film (201) is a 1 μm thick polyester coat; and the phosphor layer (27) is a 600 μm thick, vapor-deposited film of 0.03 mol % Tl-doped CsI crystals.

There may be a concern over the possibility that when a metal layer is in contact with a phosphor layer, a halogen element included in a CsI phosphor may react with moisture which has permeated through the protective film, causing corrosion of the metal layer. In this embodiment (3), however, the insulation film (201) separates the metal layer (25) from the phosphor layer (27), preventing that adhesion of phosphor constituent atoms to the metal layer (25) causes a cell reaction with the metal layer (25) which then tends to result in metal corrosion.

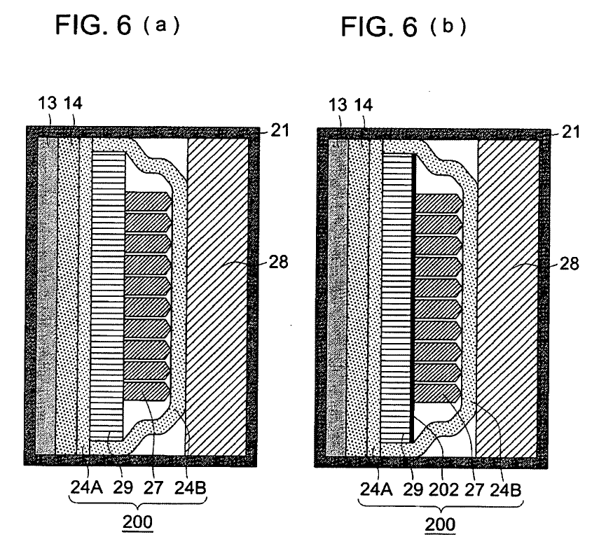

FIG. 6(a) illustrates the sectional view of a radiation detector (20) according to one embodiment (4) of the invention.

The layer arrangement is constituted of a protective film (24A), a metal substrate (29), a phosphor layer (27) and a protective film (24B) in that order. For instance, the protective film (24A or 24B) is a 50 μm thick laminated film formed of 20 μm PET/0.2 μm vapor-deposited alumina/30 μm polypropylene; the metal substrate (29) is a 0.5 mm thick Cu layer; and the phosphor layer (27) is a 600 μm thick, vapor-deposited film of 0.03 mol % Tl-doped CsI crystals.

In the embodiment (4) a substrate is not required, the constitution of a scintillator plate is simplified and the cost is also lowered, as compared to the embodiment (3).

FIG. 6(b) illustrates the sectional view of a radiation detector (20) according to one embodiment (5) of the invention.

The layer arrangement is constituted of a protective film (24A), a metal substrate (29), an insulation layer (202), a phosphor layer (27) and a protective film (24B) in that order. For instance, the protective film (24A or 24B) is a 50 μm thick laminated film formed of 20 μm PET/0.2 μm vapor-deposited alumina/30 μm polypropylene; the metal substrate (29) is a 0.5 mm thick Cu layer; the insulation film (202) is a 1 μm thick polyester coat; and the phosphor layer (27) is a 600 μm thick, vapor-deposited film of 0.03 mol % Tl-doped CsI crystals.

There may be a concern over the possibility that when a metal substrate is in contact with a phosphor layer, a halogen element included in a CsI phosphor may react with moisture which has permeated through the protective film, causing corrosion of the metal layer. In the embodiment (5), however, the insulation layer (202) separates the metal substrate (29) from the phosphor layer (27), preventing that adhesion of phosphor constituent atoms onto the metal layer (29). Thus, phosphor-constituting atoms can be prevented from causing a cell reaction with the metal substrate (29) which tends to result in metal corrosion.

In one preferred embodiment of the invention, the metal layer is constituted of a metal having an atomic number of 20 or more or an alloy having an effective atomic number of 20 or more, and having a thickness of not less than 5 μm and not more than 200 μm. This is the metal and layer thickness required to achieve elimination of low energy X-rays (scattered rays) scattered when transmitting through a subject (60) or a front plate (22). A metal substrate, which absorbs some of the high energy X-rays including image information, can be increased to a thickness of 500 μm or less to enhance the mechanical strength of the scintillator plate.

Metals having an atomic number of 20 or more and used for the metal layer or metal substrate relating to the invention include Cu, Ni, Fe, Pb, Zn, W, Mo, Au, Ag, Ba, Ta, Cd, Ti, Zr, V, Nb, Cr, Co, and Sn, which aid in elimination of low energy X-rays (scattered rays).

In the invention, the metal layer or metal substrate preferably has a columnar structure, in which X-rays parallel to the columnar structure (containing image information) are effectively permitted to effectively pass, while scattered rays not parallel to the columnar structure (containing no image information) are effectively cut-off.

The metal layer or metal substrate having a columnar structure is realized with an electrodeposited copper foil. Such an electrodeposited copper foil can be obtained, for example, in the following manner. A half of a cylindrical cathode drum of a 2 m diameter a 1 m width is immersed into an aqueous copper sulfate solution and an anode surrounding the drum is provided. Copper is electrolytically deposited on the drum to form the matt surface, which is observed to the concave-convex surface in electron microscopic observation. The electrodeposited film is peeled off from the drum to obtain an electrodeposited copper foil. The thus obtained electrodeposited copper foil forms columnar crystals extending in the deposition direction and having a diameter of 0.5-2 μm and a thickness, for example, of 50 μm.

A substrate (6) of an acryl resin, phenol resin, polyimide resin or their foams, carbon fiber reinforced resin or aluminum, often causes deformation of the metal layer of an atomic number of 20 or more at a thickness of 0.3 mm or less. It is therefore necessary to reinforce the scintillator plate with a substrate composed of a material exhibiting little absorption of X-rays. Materials exhibiting little absorption for X-rays include an acryl resin, phenol resin, polyimide resin, or their foams, carbon fiber reinforced resin and aluminum.

In the invention, a moisture resistant protective film exhibiting a moisture permeability per day of not more than 50 g/m² results in effects as below. Moisture which has entered into a scintillator plate reacts with the metal layer or the metal substrate of the scintillator plate and causes corrosion. To prevent this, it is necessary to maintain a protective film at a moisture permeability of not more than 50 g/m² per day, which can be determined by the MOCON method.

Providing an insulation layer between the metal layer or metal substrate and the phosphor layer prevents a halogen element contained in a CsI phosphor from reacting with moisture which has penetrated the protective layer, corroding the metal layer or the metal substrate.

What is claimed is:

1. A scintillator plate comprising on a substrate a metal layer and a phosphor layer capable of emitting light upon exposure to radiation, wherein all of the substrate, the phosphor layer and the metal layer are covered with a moisture-resistant protective film.

2. The scintillator plate of claim 1, wherein the scintillator plate comprises the metal layer on the substrate and the phosphor layer on the metal layer.

3. The scintillator plate of claim 1, wherein the scintillator plate comprises the metal layer on one side of the substrate and the phosphor layer on the other side of the substrate.

4. The scintillator plate of claim 1, wherein the metal layer is comprised of a metal having an atomic number of 20 or more or an alloy having an effective atomic number of 20 or more, and having a thickness of 5 to 500 μm.

5. The scintillator plate of claim 1, wherein the metal layer is comprised of a metal or alloy comprising one or more elements selected from the group consisting of Cu, Ni, Fe, Pb, Zn, W, Mo, Au, Ag, Ba, Ta, Cd, Ti, Zr, V, Nb, Cr, Co and Sn.

6. The scintillator plate of claim 1, wherein the metal layer has a columnar structure.

7. The scintillator plate of claim 1, wherein the substrate is comprised of a material selected from the group consisting of resins of an acryl resin, a phenol resin, a polyimide resin, a carbon fiber reinforced resin and aluminum.

8. The scintillator plate of claim 1, wherein the protective film exhibits a moisture permeability per day of 50 g/m² or less.

9. The scintillator plate of claim 2, wherein the scintillator plate further comprises an insulation layer provided between the metal layer and the phosphor layer.

10. The scintillator plate of claim 1, wherein the phosphor layer is comprised of at least one selected from the group consisting of CsI, CsBr and CsCl.

11. A scintillator plate comprising on a metal substrate a phosphor layer capable of emitting light upon exposure to radiation, wherein all of the metal substrate and the phosphor layer are covered with a moisture-resistant protective film.

12. The scintillator plate of claim 11, wherein the metal substrate is comprised of a metal having an atomic number of 20 or more or an alloy having an effective atomic number of 20 or more, and having a thickness of 5 to 500 μm.

13. The scintillator plate of claim 11, wherein the metal substrate is comprised of a metal or alloy comprising one or more elements selected from the group consisting of Cu, Ni, Fe, Pb, Zn, W, Mo, Au, Ag, Ba, Ta, Cd, Ti, Zr, V, Nb, Cr, Co and Sn.

14. The scintillator plate of claim 11, wherein the metal substrate has a columnar structure.

15. The scintillator plate of claim 11, wherein the protective film exhibits a moisture permeability per day of 50 g/m² or less.

16. The scintillator plate of claim 11, wherein the scintillator plate further comprises an insulation layer provided between the metal substrate and the phosphor layer.
